(19) United States
(12) Patent Application Publication
(10) Pub. No.: US 2015/0079323 A1
(43) Pub. Date: Mar. 19, 2015

(54) PNEUMATIC OBJECT PROVIDED WITH A GASTIGHT LAYER BASED ON A THERMOPLASTIC ELASTOMER AND ON A LAMELLAR FILLER

(71) Applicants: COMPAGNIE GENERALE DES ETABLISSEMENTS MICHELIN, CLERMONT-FERRAND (FR); Michelin Recherche et Technique S.A., GRANGES-PACCOT (CH)

(72) Inventors: Vincent Abad, Clermont-Ferrand Cedex 9 (FR); Vincent Lemal, Clermont-Ferrand Cedex 9 (FR); Romain Libert, Clermont-Ferrand Cedex 9 (FR)

(73) Assignee: Michelin Recherche et Technique S.A., GRANGES-PACCOT (CH)

(21) Appl. No.: 14/397,389

(22) PCT Filed: Apr. 11, 2013
(86) PCT No.: PCT/EP2013/057527

§ 371 Date: Oct. 27, 2014

(30) Foreign Application Priority Data
May 3, 2012 (FR) 1254037

(51) Int. Cl. B60C 1/00; C08K 5/01; C08K 3/34; B60C 5/02; B60C 5/14

(52) U.S. Cl. CPC B60C 1/0008; B60C 5/02; B60C 5/14; C08K 3/34; C08K 5/01
USPC 428/36.4; 152/511; 152/510

(57) ABSTRACT

A pneumatic object or inflatable article includes a gastight elastomer layer. The elastomer layer is formed of a material that includes at least one thermoplastic polyisobutylene block elastomer and a platy filler, such that relationships of:

E_{X}′/E_{Z}′>1.2 and E_{Y}′/E_{Z}′>1.2

apply, with Z being a direction normal to the elastomer layer, X and Y being directions orthogonal to Z, and E_{X}′, E_{Y}′ and E_{Z}′ being dynamic moduli in compression of the elastomer layer in the X, Y, and Z directions, respectively.

### FIELD OF THE INVENTION

The present invention relates to “pneumatic” objects or inflatable articles, that is to say, by definition, to objects which take their usable form when they are inflated with air or with an equivalent inflation gas.

It relates more particularly to the gastight layers which ensure that these pneumatic objects are airtight, in particular those of pneumatic tyres.

### PRIOR ART

In a conventional pneumatic tyre of the “tubeless” type (that is to say of the type without an inner tube), the radially internal face comprises an airtight layer (or more generally a layer airtight to any inflation gas) which makes it possible to inflate the pneumatic tyre and to keep it under pressure. Its airtightness properties allow it to guarantee a relatively low level of pressure loss, making it possible to keep the tyre inflated in a normal operating state for a sufficient period of time, normally of several weeks or several months. Another role of this layer is to protect the carcass reinforcement and more generally the remainder of the tyre from the risk of oxidation due to the diffusion of air originating from the space interior to the tyre.

This role of airtight inner layer or “inner liner” is today fulfilled by compositions based on butyl rubber (copolymer of isobutylene and isoprene), which have been recognized for a very long time for their excellent airtightness properties.

However, a well-known disadvantage of compositions based on butyl rubber is that they exhibit high hysteresis losses, furthermore over a broad temperature spectrum, which disadvantage is damaging to the rolling resistance of the pneumatic tyres.

To reduce the hysteresis of these airtight inner layers and thus, in the end, the fuel consumption of motor vehicles is a general objective which current technology comes up against.

Document WO 2009/007064 of the Applicant companies discloses a pneumatic object provided with a layer airtight to the inflation gases, in which the airtight layer comprises an elastomer composition comprising at least a styrene thermoplastic (TPS) elastomer, a platy filler and optionally a polybutene oil. In comparison with a butyl rubber, the TPS elastomer exhibits the major advantage, due to its thermoplastic nature, of being able to be worked as is in the molten (liquid) state and consequently of offering the possibility of simplified processing while ensuring an airtightness at least equal to if not greater than that obtained with a conventional airtight layer made of butyl rubber. But this document does not give any indication regarding the physical characteristics of the compositions.

### BRIEF DESCRIPTION OF THE INVENTION

Thus, the invention relates to a pneumatic object or inflatable article provided with a gastight elastomer layer comprising, as the sole elastomer or as the predominant elastomer by weight, at least one thermoplastic polyisobutylene block elastomer and a platy filler, characterized in that, Z being a direction normal to said airtight elastomer layer, X and Y two directions orthogonal to Z, and E_{X}′, E_{Y}′ and E_{Z}′ being the dynamic moduli in compression of said airtight elastomer layer respectively in the directions X, Y and Z, the following apply:

E_{X}′/E_{Z}′>1.2 and E_{Y}′/E_{Z}′>1.2

Preferably, the following apply:

E_{X}′/E_{Z}′>1.5 and E_{Y}′/E_{Z}′>1.5

The highly anisotropic gastight layer thus defined has the advantage of having a much lower permeability to gases in the Z direction, normal to the airtight layer, than an airtight layer of the same composition but having isotropic mechanical behaviour.

The invention relates more particularly to the pneumatic tyres intended to be fitted on motor vehicles of the passenger type, SUVs (Sport Utility Vehicles), two-wheel vehicles (especially motorcycles), aircraft, and also industrial vehicles selected from vans, “heavy-duty” vehicles, i.e. underground trains, buses, heavy road transport vehicles (lorries, tractors, trailers), off-road vehicles, such as agricultural or civil engineering machines, and other transport or handling vehicles.

### I. DESCRIPTION OF THE FIGURE

The invention and its advantages will be easily understood in the light of the description and the exemplary embodiments that follow, and also from the following appended FIGURE in which:

FIG. 1 represents, very schematically, a radial cross section of a pneumatic tyre in accordance with the invention.

### II. DETAILED DESCRIPTION OF THE INVENTION

In the present description, unless expressly indicated otherwise, all the percentages (%) shown are % by weight. The volume percentage of a constituent of a composition is understood to mean the percentage, by volume, of this constituent relative to the volume of the whole of the composition.

Furthermore, any range of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b).

### II-1. Gastight Elastomer Composition

The pneumatic object according to the invention is provided with an elastomer layer which is airtight to the inflation gases, comprising at least, as the sole elastomer or as the predominant elastomer by weight present in said composition, a thermoplastic polyisobutylene block elastomer, associated with which is a platy filler, and optionally an extender oil of the thermoplastic polyisobutylene block elastomer.

### II-1-A. Thermoplastic Polyisobutylene Block Elastomer

Thermoplastic elastomers have a structure intermediate between thermoplastic polymers and elastomers. They are composed of rigid thermoplastic sequences connected via flexible elastomer sequences, for example polybutadiene, polyisoprene, poly(ethylene/butylene) or polyisobutylene. They are often triblock elastomers with two rigid segments connected via a flexible segment. The rigid and flexible segments can be positioned linearly, in star fashion or in branched fashion. Typically, each of these segments or blocks comprises at least more than 5, generally more than 10, base units (for example, styrene units and isoprene units for a styrene/isoprene/styrene block copolymer).

The number-average molecular weight (denoted Mₙ) of the thermoplastic polyisobutylene block elastomer (hereinafter abbreviated to “TPEI”) is preferably between 30 000 and 500 000 g/mol, more preferably between 40 000 and 400 000 g/mol. Below the minima indicated, there is a risk of the cohesion between the chains of the TPEI being affected, in particular due to its possible dilution (in the presence of an extender oil); moreover, an increase in the operating temperature risks affecting the mechanical properties, in particular the properties at break, with a consequence of a reduced performance “under hot conditions”. Furthermore, an excessively high weight Mₙ can be damaging with regard to the flexibility of the gastight layer. Thus, it has been found that a value within a range from 50 000 to 300 000 g/mol is particularly well suited, in particular to use of the thermoplastic polyisobutylene block elastomer or TPEI in a pneumatic tyre composition.

The number-average molecular weight (Mₙ) of the TPEI is determined in a known way by size exclusion chromatography (SEC). The sample is dissolved beforehand in tetrahydrofuran at a concentration of approximately 1 g/l; the solution is then filtered through a filter with a porosity of 0.45 μm before injection. The equipment used is a “Waters alliance” chromatographic line. The elution solvent is tetrahydrofuran, the flow rate is 0.7 ml/min, the temperature of the system is 35° C. and the analytical time is 90 min. A set of four Waters columns in series, with “Styragel” trade names (“HMW7”, “HMW6E” and two “HT6E”), is used. The injected volume of the solution of the polymer sample is 100 μl. The detector is a “Waters 2410” differential refractometer and its associated software for handling the chromatographic data is the “Waters Millenium” system. The calculated average molar masses are relative to a calibration curve produced with polystyrene standards.

The polydispersity index Iₚ (it should be remembered that Iₚ=M_{w}/Mₙ with M_{w} the weight-average molecular weight) of the TPEI is preferably less than 3; more preferably Iₚ is less than 2 and more preferably still less than 1.5.

The elastomer block is composed predominantly of the polymerized isobutylene monomer. Preferably, the polyisobutylene block of the block copolymer has a number-average molecular weight (“Mₙ”) ranging from 25 000 g/mol to 350 000 g/mol, preferably from 35 000 g/mol to 250 000 g/mol, so as to confer, on the thermoplastic elastomer, good elastomeric properties and a mechanical strength which is sufficient and compatible with the pneumatic tyre inner liner application.

Preferably, the polyisobutylene block of the TPEI or block copolymer additionally has a glass transition temperature (“T_{g}”) of less than or equal to −20° C., more preferably of less than −40° C. A T_{g} value greater than these minima may reduce the performance of the airtight layer during use at very low temperature; for such a use, the T_{g} of the polyisobutylene block of the block copolymer is more preferably still less than −50° C.

The polyisobutylene block of the TPEI can also advantageously comprise a content of units resulting from one or more conjugated dienes inserted into the polymer chain preferably ranging up to 16% by weight relative to the weight of the polyisobutylene block. Above 16%, a fall in the resistance to thermal oxidation and to oxidation by ozone may be observed for the airtight layer comprising the thermoplastic polyisobutylene block elastomer used in a tyre.

The conjugated dienes which can be copolymerized with the isobutylene in order to form the polyisobutylene block are conjugated C₄-C₁₄ dienes. Preferably, these conjugated dienes are selected from isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,3-dimethyl-1,3-hexadiene, 2,4-dimethyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or their mixture. More preferably, the conjugated diene is isoprene or a mixture containing isoprene.

The polyisobutylene block, according to an advantageous aspect of the subject of the invention, can be halogenated and can comprise halogen atoms in its chain. This halogenation makes it possible to improve the compatibility of the airtight layer with the other adjacent constituent components of the pneumatic object, in particular of a pneumatic tyre. Halogenation is carried out by means of bromine or chlorine, preferably bromine, on the units resulting from conjugated dienes of the polymer chain of the polyisobutylene block. Only a portion of these units reacts with the halogen.

According to a first embodiment, the TPEI is selected from styrene thermoplastic elastomers containing a polyisobutylene block (“TPSI”).

The additional thermoplastic block or blocks of the polyisobutylene block (hereinafter denoted by “Additional Block”) are thus composed of at least one polymerized monomer based on unsubstituted or substituted styrene; mention may be made, among substituted styrenes, for example, of methylstyrenes (for example, o-methylstyrene, m-methylstyrene or p-methylstyrene, α-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or para-hydroxystyrene.

Preferably, the TPSI thermoplastic elastomer is a polystyrene and polyisobutylene block copolymer.

Preferably, such a block copolymer is a styrene/isobutylene diblock copolymer (abbreviated to “SIB”).

More preferably still, such a block copolymer is a styrene/isobutylene/styrene triblock copolymer (abbreviated to “SIBS”).

According to a preferred embodiment of the invention, the weight content of styrene (unsubstituted or substituted) in the styrene elastomer is between 5% and 50%. Below the minimum indicated, the thermoplastic nature of the elastomer risks being substantially reduced, whereas, above the recommended maximum, the elasticity of the airtight layer may be affected. For these reasons, the styrene content is more preferably between 10% and 40%, in particular between 15% and 35%.

Preferably, the glass transition temperatures of the Additional Blocks formed from styrenic polymerized monomers are greater than or equal to 100° C., preferably greater than or equal to 130° C., more preferably still greater than or equal to 150° C., or even greater than or equal to 200° C.

The TPSI elastomer, optionally extended with a polybutene oil, is preferably the only constituent thermoplastic elastomer of the gastight elastomer layer matrix.

The TPSI elastomers can be processed conventionally, by extrusion or moulding, for example starting from a raw material available in the form of beads or granules.

The TPSI elastomers are available commercially, for example sold, as regards the SIB and SIBS, by Kaneka under the name “Sibstar” (e.g. “Sibstar 103T”, “Sibstar 102T”, “Sibstar 073T” or “Sibstar 072T” for the SIBSs or “Sibstar 042D” for the SIBs). They have, for example, been described, along with their synthesis, in the patent documents EP 731 112, U.S. Pat. No. 4,946,899 and U.S. Pat. No. 5,260,383. They were developed first of all for biomedical applications and then described in various applications specific to TPSI elastomers, as varied as medical equipment, motor vehicle or domestic electrical appliance parts, sheathings for electric wires, or airtight or elastic parts (see, for example, EP 1 431 343, EP 1 561 783, EP 1 566 405 and WO 2005/103146).

According to a second embodiment, the TPEI elastomers can also comprise at least one Additional Block formed from polymerized monomers other than styrene monomers (abbreviated to “TPNSI”). Such monomers can be selected from the following compounds and mixtures thereof:
acenaphthylene: a person skilled in the art may, for example, refer to the article by Z. Fodor and J. P. Kennedy, Polymer Bulletin, 1992, 29(6), 697-705;
indene and its derivatives, such as, for example, 2-methylindene, 3-methylindene, 4-methylindene, dimethylindenes, 2-phenylindene, 3-phenylindene and 4-phenylindene; a person skilled in the art may, for example, refer to the patent document U.S. Pat. No. 4,946,899 by the inventors Kennedy, Puskas, Kaszas and Hager and to the documents J. E. Puskas, G. Kaszas, J. P. Kennedy and W. G. Hager, Journal of Polymer Science, Part A: Polymer Chemistry (1992), 30, 41, and J. P. Kennedy, N. Meguriya and B. Keszler, Macromolecules (1991), 24(25), 6572-6577;
isoprene, then resulting in the formation of a number of trans-1,4-polyisoprene units and of units cyclized according to an intramolecular process; a person skilled in the art may, for example, refer to the documents G. Kaszas, J. E. Puskas and P. Kennedy, Applied Polymer Science (1990), 39(1), 119-144, and J. E. Puskas, G. Kaszas and J. P. Kennedy, Macromolecular Science, Chemistry A28 (1991), 65-80;
esters of acrylic acid, crotonic acid, sorbic acid and methacrylic acid, derivatives of acrylamide, derivatives of methacrylamide, derivatives of acrylonitrile, derivatives of methacrylonitrile and mixtures thereof. Mention may more particularly be made of adamantyl acrylate, adamantyl crotonate, adamantyl sorbate, 4-biphenylyl acrylate, tert-butyl acrylate, cyanomethyl acrylate, 2-cyanoethyl acrylate, 2-cyanobutyl acrylate, 2-cyanohexyl acrylate, 2-cyanoheptyl acrylate, 3,5-dimethyladamantyl acrylate, 3,5-dimethyladamantyl crotonate, isobornyl acrylate, pentachlorobenzyl acrylate, pentafluorobenzyl acrylate, pentachlorophenyl acrylate, pentafluorophenyl acrylate, adamantyl methacrylate, 4-(tert-butyl)cyclohexyl methacrylate, tert-butyl methacrylate, 4-(tert-butyl)phenyl methacrylate, 4-cyanophenyl methacrylate, 4-cyanomethylphenyl methacrylate, cyclohexyl methacrylate, 3,5-dimethyladamantyl methacrylate, dimethylaminoethyl methacrylate, 3,3-dimethylbutyl methacrylate, methacrylic acid, methyl methacrylate, ethyl methacrylate, phenyl methacrylate, isobornyl methacrylate, tetradecyl methacrylate, trimethylsilyl methacrylate, 2,3-xylenyl methacrylate, 2,6-xylenyl methacrylate, acrylamide, N-(sec-butyl)acrylamide, N-(tert-butyl)acrylamide, N,N-diisopropylacrylamide, N-(1-methylbutyl)acrylamide, N-methyl-N-phenylacrylamide, morpholylacrylamide, piperidylacrylamide, N-(tert-butyl)methacrylamide, 4-butoxycarbonylphenylmethacrylamide, 4-carboxyphenylmethacrylamide, 4-methoxycarbonylphenylmethacrylamide, 4-ethoxycarbonylphenylmethacrylamide, butyl cyanoacrylate, methyl chloroacrylate, ethyl chloroacrylate, isopropyl chloroacrylate, isobutyl chloroacrylate, cyclohexyl chloroacrylate, methyl fluoromethacrylate, methyl phenylacrylate, acrylonitrile, methacrylonitrile and mixtures thereof.

Preferably, the glass transition temperatures of these Additional Blocks formed from polymerized monomers other than styrene monomers are greater than or equal to 100° C., preferably greater than or equal to 130° C., more preferably still greater than or equal to 150° C., or even greater than or equal to 200° C.

According to one alternative form, the polymerized monomer other than a styrene monomer can be copolymerized with at least one other monomer so as to form a rigid thermoplastic block. According to this aspect, the molar fraction of polymerized monomer other than a styrene monomer, with respect to the total number of units of the thermoplastic block, must be sufficient to achieve a T_{g} of greater than or equal to 100° C., preferably of greater than or equal to 130° C., more preferably still of greater than or equal to 150° C., or even of greater than or equal to 200° C. Advantageously, the molar fraction of this other comonomer can range from 0 to 90%, more preferably from 0 to 75% and more preferably still from 0 to 50%.

By way of illustration, this other monomer capable of copolymerizing with the polymerized monomer other than a styrene monomer can be selected from diene monomers, more particularly conjugated diene monomers having from 4 to 14 carbon atoms, and monomers of vinylaromatic type having from 8 to 20 carbon atoms.

When the comonomer is a conjugated diene having from 4 to 14 carbon atoms, it advantageously represents a molar fraction, with respect to the total number of units of the thermoplastic block, ranging from 0 to 25%. Suitable as conjugated dienes which can be used in the thermoplastic blocks according to one subject of the invention are those described above, namely isoprene, butadiene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 1,3-hexadiene, 2-methyl-1,3-hexadiene, 3-methyl-1,3-hexadiene, 4-methyl-1,3-hexadiene, 5-methyl-1,3-hexadiene, 2,5-dimethyl-1,3-hexadiene, 2-neopentylbutadiene, 1,3-cyclopentadiene, 1,3-cyclohexadiene, 1-vinyl-1,3-cyclohexadiene or mixtures thereof.

When the comonomer is of vinylaromatic type, it advantageously represents a fraction of units, with regard to the total number of units of the Additional Block, from 0 to 90%, preferably ranging from 0 to 75% and more preferably still ranging from 0 to 50%. Suitable in particular as vinylaromatic compounds are the abovementioned styrene monomers, namely methylstyrenes, para-(tert-butyl)styrene, chlorostyrenes, bromostyrenes, fluorostyrenes or para-hydroxystyrene. Preferably, the comonomer of vinylaromatic type is styrene.

Mention may be made, as illustrative but nonlimiting examples, of mixtures of comonomers, which can be used for the preparation of Additional Blocks, composed of indene and of styrene derivatives, in particular para-methylstyrene or para-(tert-butyl)styrene. A person skilled in the art may then refer to the documents: J. E. Puskas, G. Kaszas, J. P. Kennedy and W. G. Hager, Journal of Polymer Science, Part A: Polymer Chemistry, 1992, 30, 41, or J. P. Kennedy, S. Midha and Y. Tsungae, Macromolecules (1993), 26, 429.

Preferably, a TPNSI thermoplastic elastomer is a diblock copolymer: thermoplastic block/isobutylene block. More preferably still, such a TPNSI thermoplastic elastomer is a triblock copolymer: thermoplastic block/isobutylene block/thermoplastic block.

The TPSI or TPNSI block thermoplastic elastomer according to the invention as defined previously may by itself constitute the matrix of the elastomeric composition or may be combined, in this composition, with other constituents in order to form an elastomeric matrix.

If other optional elastomers are used in this composition, the block copolymer as described previously constitutes the predominant elastomer by weight, i.e. the weight fraction of the block copolymer relative to all of the constituent elastomers of the elastomer matrix is the highest. The block copolymer preferably represents more than 50% and more preferably more than 70% by weight of all of the elastomers. Such additional elastomers may, for example, be diene elastomers or thermoplastic styrene (TPS) elastomers, within the limit of the compatibility of their microstructures

As diene elastomers that can be used in addition to the block copolymer described previously, mention may be made especially of polybutadienes (BR), synthetic polyisoprenes (IR), natural rubber (NR), butadiene copolymers, isoprene copolymers and mixtures of these elastomers. Such copolymers are more preferably selected from the group consisting of butadiene-styrene copolymers (SBR), isoprene-butadiene copolymers (BIR), isoprene-styrene copolymers (SIR), isoprene-isobutylene copolymers (IIR) and halogenated versions thereof, isoprene-butadiene-styrene copolymers (SBIR), and mixtures of such copolymers.

As TPE thermoplastic elastomer that can be used in addition to the block copolymer described previously, mention may be made especially of a TPS elastomer selected from the group consisting of styrene/butadiene/styrene (SBS) block copolymers, styrene/isoprene/styrene (SIS) and styrene/butylene/styrene block copolymers, styrene/butadiene/isoprene/styrene (SBIS) block copolymers, styrene/ethylene/butylene/styrene (SEBS) block copolymers, styrene/ethylene/propylene/styrene (SEPS) block copolymers, styrene/ethylene/ethylene/propylene/styrene (SEEPS) block copolymers, styrene/ethylene/ethylene/styrene (SEES) block copolymers, and mixtures of these copolymers. More preferably, said optional additional TPS elastomer is selected from the group consisting of SEBS block copolymers, SEPS block copolymers and mixtures of these copolymers.

### II-1-B. Platy Filler

One essential feature of the airtight layer or inflatable article according to one of the subject matters of the invention is to comprise a platy filler. The use of platy filler advantageously makes it possible to lower the permeability coefficient (and thus to increase the airtightness) of the elastomer composition without excessively increasing its modulus, which makes it possible to retain the ease of incorporation of the airtight layer in the pneumatic object.

“Platy” fillers are well known to a person skilled in the art. They have been used in particular in pneumatic tyres to reduce the permeability of conventional gastight layers based on butyl rubber. They are generally used in these butyl-based layers at relatively low contents not exceeding generally from 10 to 15 parts by weight per hundred parts of elastomer (phr), (see, for example, the patent documents US 2004/0194863 and WO 2006/047509).

They are generally provided in the form of stacked plates, platelets, sheets or lamellae, with a more or less marked anisometry. Their aspect ratio (A=L/T) is generally greater than 3, more often greater than 5 or than 10, L representing the length (or greatest dimension) and T representing the average thickness of these platy fillers, these averages being calculated as number averages. Aspect ratios reaching several tens, indeed even several hundreds, are common. Their average length is preferably greater than 1 μm (that is to say that “micrometre-sized” platy fillers are then involved), typically between several μm (for example 5 μm) and several hundred μm (for example 500 μm, indeed even 800 μm).

Preferably, the platy fillers used are selected from the group consisting of graphites, phyllosilicates and the mixtures of such fillers. Mention will in particular be made, among phyllosilicates, of clays, talcs, micas or kaolins, it being possible for these phyllosilicates to be unmodified or to be modified, for example by a surface treatment; mention may in particular be made, as examples of such modified phyllosilicates, of micas covered with titanium oxide or clays modified by surfactants (“organo clays”).

Use is preferably made of platy fillers having a low surface energy, that is to say which are relatively apolar, such as those selected from the group consisting of graphites, talcs, micas and the mixtures of such fillers, it being possible for the latter to be modified or unmodified, more preferably still selected from the group consisting of micas and the mixtures of such fillers.

Mention may in particular be made, among graphites, of natural graphites, expanded graphites or synthetic graphites.

Mention may be made, as examples of talcs, of the talcs sold by Luzenac.

Mention may be made, as examples of graphites, of the graphites sold by Timcal (“Timrex” range).

Mention may be made, as examples of micas, of the micas sold by CMMP (“Mica-MU”, “Mica-Soft” and “Briomica”, for example), the micas sold by Yamaguchi (A51S, A41S, SYA-21R, SYA-21RS, A21S and SYA-41R), vermiculites (in particular the vermiculite “Shawatec” sold by CMMP or the vermiculite “Microlite” sold by W.R. Grace) or modified or treated micas (for example, the “Iriodin” range sold by Merck).

The platy fillers described above can be used at variable contents, in particular between 2% and 30% and preferably between 3% and 20% by volume of elastomer composition.

The introduction of the platy fillers into the thermoplastic elastomer composition can be carried out according to various known processes, for example by twin-screw extrusion.

It is particularly interesting to note that during the introduction of the platy fillers into a thermoplastic block elastomer in the liquid state, the shear stresses in the composition are very reduced and only very slightly modify the size distributions and the initial aspect ratio of the platy fillers.

### II-1-C. Extender Oil

The thermoplastic polyisobutylene block elastomers and the platy fillers that are described above are sufficient by themselves alone to fulfil the function of gastightness with regard to the pneumatic objects in which they are used.

However, according to a preferred embodiment of the invention, the elastomer composition described above also comprises, as plasticizing agent, an extender oil (or plasticizing oil), the role of which is to facilitate the processing of the gastight layer, particularly its incorporation in the pneumatic object, by a lowering of the modulus and an increase in the tackifying power.

Use may be made of any extender oil, preferably having a weakly polar nature, capable of extending or plasticizing elastomers, in particular thermoplastic elastomers. At ambient temperature (23° C.), these oils, which are more or less viscous, are liquids (that is to say, to recapitulate, substances having the ability to eventually assume the shape of their container), in contrast in particular to resins or rubbers, which are solids by nature.

Preferably, the extender oil is selected from the group consisting of polyolefin oils (that is to say, resulting from the polymerization of olefins, monoolefins or diolefins), paraffinic oils, naphthenic oils (of low or high viscosity), aromatic oils, mineral oils and mixtures of these oils.

While it has been found that the addition of oil admittedly takes place at the cost of a certain loss in airtightness, which can vary according to the type and the amount of oil used, this loss in airtightness can be largely mitigated by adjusting the content of the platy filler.

Use is preferably made of an oil of polybutene type, in particular a polyisobutylene oil (abbreviated to “PIB”), which has demonstrated the best compromise in properties in comparison with the other oils tested, in particular with a conventional oil of the paraffinic type.

By way of examples, polyisobutylene oils are sold in particular by Univar under the name “Dynapak Poly” (e.g., “Dynapak Poly 190”), by Ineos Oligomer under the name “Indopol H1200” or by BASF under the names “Glissopal” (e.g., “Glissopal 1000”) or “Oppanol” (e.g., “Oppanol B12”); paraffinic oils are sold, for example, by Exxon under the name “Telura 618” or by Repsol under the name “Extensol 51”.

The number-average molecular weight (Mₙ) of the extender oil is preferably between 200 and 25 000 g/mol and more preferably still between 300 and 10 000 g/mol. For excessively low Mₙ weights, there exists a risk of migration of the oil outside the composition, whereas excessively high weights can result in excessive stiffening of this composition. An Mₙ weight of between 350 and 4000 g/mol, in particular between 400 and 3000 g/mol, has proved to constitute an excellent compromise for the target applications, in particular for use in a pneumatic tyre.

The number-average molecular weight (Mₙ) of the extender oil is determined by SEC, the sample being dissolved beforehand in tetrahydrofuran at a concentration of approximately 1 g/l; the solution is then filtered through a filter with a porosity of 0.45 μm before injection. The equipment is the “Waters Alliance” chromatographic line. The elution solvent is tetrahydrofuran, the flow rate is 1 ml/min, the temperature of the system is 35° C. and the analytic time is 30 min. Use is made of a set of two “Waters” columns bearing the name “Styragel HT6E”. The injected volume of the solution of the polymer sample is 100 μl. The detector is a “Waters 2410” differential refractometer and its associated software for handling the chromatographic data is the “Waters Millenium” system. The calculated average molar masses are relative to a calibration curve produced with polystyrene standards.

A person skilled in the art will know how, in the light of the description and exemplary embodiments which follow, to adjust the amount of extender oil as a function of the specific conditions of use of the gastight elastomer layer, in particular of the pneumatic object in which it is intended to be used.

It is preferable for the content of extender oil to be greater than 5 parts by weight per hundred parts of thermoplastic polyisobutylene block elastomer, preferably between 5 and 150 parts.

Below the minimum indicated, the presence of extender oil is not noticeable. Above the recommended maximum, the risk is encountered of insufficient cohesion of the composition and of loss in airtightness which may be harmful depending on the application under consideration.

For these reasons, in particular for use of the airtight composition in a pneumatic tyre, it is preferable for the content of extender oil to be greater than 10 parts, in particular between 10 and 130 parts, more preferably still for it to be greater than 20 parts, in particular between 20 and 100 parts.

### II-1-D. Various Additives

The airtight layer or composition described above can furthermore comprise the various additives normally present in the airtight layers known to a person skilled in the art. Mention will be made, for example, of reinforcing fillers, such as carbon black or silica, non-reinforcing or inert fillers other than the fillers described above, colouring agents which can advantageously be used for the colouring of the composition, plasticizers other than the abovementioned extender oils, tackifying resins, protecting agents, such as antioxidants or antiozonants, UV stabilizers, various processing aids or other stabilizing agents, or promoters capable of promoting the adhesion to the remainder of the structure of the pneumatic object.

The gastight layer or composition described above is a compound that is solid (at 23° C.) and elastic, which is characterized in particular, owing to its specific formulation, by a very high flexibility and very high deformability.

### II-2. Manufacture of the Airtight Elastomer Composition

The manufacture of the airtight elastomer composition is advantageously carried out using an extrusion tool, preferably with a twin-screw extruder. Such an extruder makes it possible to obtain both the melting of the thermoplastic constituent(s) of the composition and the intimate kneading thereof with the other constituents of the composition.

T_{M1} is considered to be the given melting or softening temperature of the thermoplastic block elastomer.

The manufacturing process comprises the following steps:
introducing the thermoplastic elastomer and the other constituents of the composition, in particular the platy fillers, into one or more feeds of the twin-screw extruder;
melting and kneading the constituents by bringing all the constituents to a kneading temperature (T_{M}) above the given melting or softening temperature (T_{M1}) during the transfer into the body of the twin-screw extruder; and
dispensing the resulting composition at the outlet of the twin-screw extruder with a die of suitable cross section.

The body of the twin-screw extruder is brought to a temperature T_{M} above the melting or softening temperature of the thermoplastic polyisobutylene block elastomer of the composition. This makes it possible to carry out, during the transfer of the constituents into the body of the extruder, both the melting of the thermoplastic constituent and the kneading thereof. The difference in temperature must be greater than 5° C. in order for the melting to be complete, and is preferably greater than 10° C.

At the outlet of the twin-screw extruder it is possible to install a die having a cross section suitable for the intended use of the airtight elastomer layer. A sheet die is preferably used in order to obtain a flat profiled element ready to be introduced into the blank of the pneumatic tyre.

At the outlet of the die, as is well known to those skilled in the art, the profiled element may be received by a protective liner placed on a moving belt and then stored in the form of a reel.

It is possible to introduce at the same time as the thermoplastic polyisobutylene block elastomer, or subsequently, the optional extender oil of the composition and the optional additives.

### II-3. Use of the Airtight Layer in a Pneumatic Tyre

The composition based on thermoplastic elastomer described above can be used as airtight layer in any type of pneumatic object or inflatable article. Mention may be made, as examples of such pneumatic objects or inflatable articles, of inflatable boats, or balloons or balls used for play or sport.

It is particularly well suited to use as an airtight layer (or layer airtight to any other inflation gas, for example nitrogen) in a pneumatic object, finished product or semi-finished product made of rubber, very particularly in an inner tube, in a pneumatic tyre inner tube and in a pneumatic tyre for a motor vehicle such as a vehicle of two-wheel, passenger or industrial type.

Such an airtight layer is preferably positioned on the internal wall of the pneumatic object, but it can also be fully incorporated in its internal structure.

The thickness of the airtight layer is preferably greater than 0.05 mm, more preferably between 0.1 mm and 10 mm (in particular between 0.1 and 1.0 mm).

It will be easily understood that, depending on the specific fields of application, the dimensions and the pressures at work, the embodiment of the invention can vary, the airtight layer then having several preferred thickness ranges.

Thus, for example, for pneumatic tyres of passenger vehicle type, it can have a thickness of at least 0.4 mm, preferably of between 0.8 and 2 mm. According to another example, for pneumatic tyres for heavy-duty or agricultural vehicles, the preferred thickness can be between 1 and 3 mm.

According to another example, for pneumatic tyres for vehicles in the civil engineering field or for aircraft, the preferred thickness can be between 2 and 10 mm.

### III. EXEMPLARY EMBODIMENTS OF THE INVENTION

The gastight layer described above can advantageously be used in pneumatic tyres for all types of vehicles, in particular passenger vehicles or industrial vehicles, such as heavy-duty vehicles.

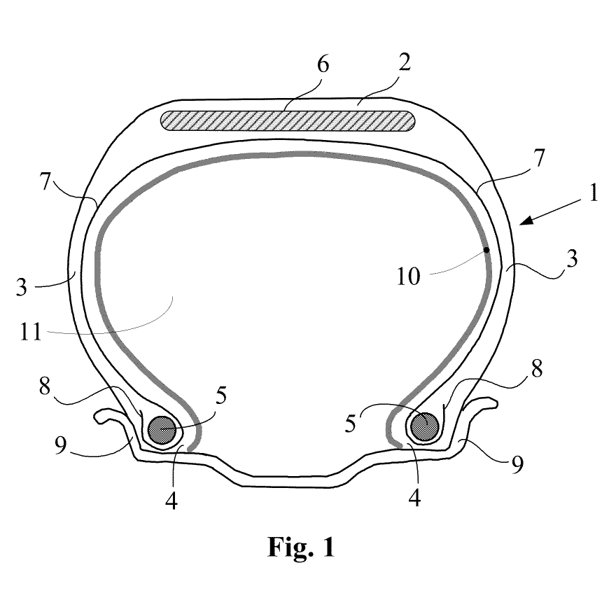

By way of example, appended FIG. 1 represents, highly schematically (not to a specific scale), a radial cross section of a pneumatic tyre in accordance with the invention.

This pneumatic tyre 1 comprises a crown 2 reinforced by a crown reinforcement or belt 6, two sidewalls 3 and two beads 4, each of these beads 4 being reinforced with a bead wire 5. The crown 2 is surmounted by a tread not represented in this schematic FIGURE. A carcass reinforcement 7 is wound around the two bead wires 5 in each bead 4, the turn-up 8 of this reinforcement 7 being, for example, positioned towards the outside of the tyre 1, which is here represented fitted on its rim 9. The carcass reinforcement 7 is, in a way known per se, composed of at least one ply reinforced by “radial” cords, for example textile or metal cords, that is to say that these cords are positioned virtually parallel to one another and extend from one bead to the other, so as to form an angle of between 80° and 90° with the median circumferential plane (plane perpendicular to the axis of rotation of the tyre which is situated at mid-distance from the two beads 4 and passes through the middle of the crown reinforcement 6).

The internal wall of the pneumatic tyre 1 comprises an airtight layer 10, for example with a thickness equal to approximately 0.9 mm, on the side of the internal cavity 11 of the pneumatic tyre 1.

This inner layer (or “inner liner”) covers the whole of the internal wall of the pneumatic tyre, extending from one sidewall to the other, at least up to the level of the rim flange when the pneumatic tyre is in the fitted position. It defines the radially internal face of said tyre intended to protect the carcass reinforcement from the diffusion of air originating from the space 11 interior to the tyre. It enables the pneumatic tyre to be inflated and kept under pressure. Its airtightness properties must allow it to guarantee a relatively low degree of pressure loss and to keep the tyre inflated, in the normal operating state, for a sufficient period of time, normally of several weeks or several months.

Unlike a conventional pneumatic tyre that uses a composition based on butyl rubber, the pneumatic tyre according to the invention uses, in this example, as the airtight layer 10, an elastomer composition comprising a SIBS elastomer (“Sibstar 102T” with a styrene content of approximately 15%, a T_{g} of the polyisobutylene block of approximately −65° C. and an Mₙ of approximately 90 000 g/mol), and a platy filler in a content of 5% by volume (Yamaguchi Mica SYA21R), this composition being extended here with a PIB oil (for example, 66 parts of “H-1200 INEOS” oil).

The tyre provided with its airtight layer 10 as described above may be produced before or after vulcanization (or curing).

In the first case (i.e., before curing of the pneumatic tyre), the airtight layer is simply applied in a conventional manner at the desired place, so as to form the layer 10. The vulcanization is then carried out conventionally.

An advantageous variant of manufacture for a person skilled in the art of pneumatic tyres consists, for example, during a first step, in laying down, flat, the airtight layer directly on a building drum, in the form of a layer (“skim”) of suitable thickness, before covering the latter with the remainder of the structure of the pneumatic tyre, according to manufacturing techniques well known to a person skilled in the art.

In the second case (i.e. after curing of the pneumatic tyre), the airtight layer is applied to the inside of the cured pneumatic tyre by any appropriate means, for example by bonding, by spraying or else extrusion and direct application of a profiled element of suitable thickness.

### III-1. Tests

A Airtightness Test

In the following examples the airtightness properties were analysed on test specimens of compositions based on thermoplastic elastomer with platy filler and on various methods for obtaining them.

Use was made, for this analysis, of a rigid-wall permeameter, placed in an oven (temperature at 60° C. in the present case), equipped with a relative pressure sensor (calibrated in the range from 0 to 6 bar) and connected to a tube equipped with an inflation valve. The permeameter can receive standard test specimens in disc form (for example, with a diameter of 65 mm in the present case) and with a uniform thickness which can range up to 3 mm (0.5 mm in the present case). The pressure sensor is connected to a National Instruments data acquisition card (0-10 V analogue four-channel acquisition) which is connected to a computer carrying out continuous acquisition with a frequency of 0.5 Hz (1 point every two seconds). The permeability coefficient (K) is measured from the linear regression line giving the slope a of the pressure loss through the test specimen tested as a function of the time, after stabilization of the system, that is to say the achievement of stable conditions under which the pressure decreases linearly as a function of the time. The initial measurement pressure is, for example, between 4 and 3.4 bar. An arbitrary value of 100 is given for the airtightness of the control, a result above 100 indicating an increase in the airtightness and therefore a reduction in the permeability.

B Dynamic Characterizations

The dynamic characterizations are carried out on a dynamic mechanical analyzer DMA+450 from the company ACOEM. The analyzer is equipped with PET10003000B compression plates.

The samples are cylindrical samples having a diameter of 10 mm and a height of 12 mm. They are positioned, without bonding, at the centre of the compression plates.

The test consists, at a fixed temperature of 40° C. and a frequency of 1 Hz, in applying a static compressive stress of 25.5 kPa to which a dynamic stress of ±3.8 kPa is added.

The actual dynamic modulus E′ is recorded at the end of 30 minutes, the time for which the value is stable.

### III-2. Tests

A Formulation

A gastight composition containing the components presented in Table 1 was prepared according to two different embodiments.

The content of plasticizer is expressed in phr, those of the platy filler in % by volume (relative to the total volume of the SIBS elastomer composition) and also in phr (relative to the weight of SIBS elastomer). The term “phr” is understood here to mean parts by weight per 100 parts by weight of SIBS elastomer.

TABLE 1

| Composition | |
|---|---|
| SIBS - Sibstar 102 T - KANEKA - (phr) | 100 |
| PIB H1200 oil - INEOS - (phr) | 66.7 |
| SYA21R YAMAGUCHI - % by volume (phr) | 5% (27.2) |

The density of the SIBS is 0.94 g/cm³, that of the PIB oil is 0.89 g/cm³ and that of the SYA21R mica is 2.85 g/cm³.

B Sample Preparation

An airtight elastomer layer having a composition as described in Table 1 was produced by means of a twin-screw extruder.

The thickness of the layer after cooling was 0.5 mm. Sheets of 150 mm by 150 mm were cut from this airtight elastomer layer.

The following are considered:
X, the direction of extrusion (in the plane of the sheets);
Y, the direction orthogonal to X in the plane of the sheet, or cross direction; and
Z, the direction normal to the sheet.

In order to obtain the samples needed for the dynamic measurement tests for the airtight elastomer layer as obtained directly (Test specimens A), several sheets were assembled in a press, then the assembly was brought to 180° C. under a pressure of 4 bar for 10 minutes and a slab having a thickness of the order of 12 mm was obtained.

After cooling, cylindrical test specimens having a thickness of 12 mm and a diameter of 10 mm were cut from the slab along the three defined orientations, X, Y and Z.

In order to obtain isotropic samples (Test specimens B), several sheets of the airtight elastomer layer were submerged in liquid nitrogen then ground to give a fine powder thereof. The powder was then dispersed in a mould which was pressed with a very low pressure in order to obtain, on the one hand, a layer having a thickness of the order of 0.5 mm for the permeability test and on the other hand a slab having dimensions similar to the previous one by limiting the movements of material.

After cooling, as above, cylindrical test specimens were cut from the slab along the three defined orientations.

C Test Results

Table 2 presents the results of the airtightness and dynamic measurement tests carried out on these test specimens.

TABLE 2

| Results | B | A |
|---|---|---|
| E′_{X} (MPa) | 1.25 | 1.6 |
| E′_{Y} (MPa) | 1.25 | 1.6 |
| E′_{Z} (MPa) | 1.25 | 1.0 |
| relative airtightness (%) | 100 | 127 |

It is observed that the test specimens B exhibit isotropic dynamic mechanical behaviour.

On the other hand, the test specimens A exhibit high anisotropy of the dynamic modulus in compression: the ratios between the dynamic moduli in compression in the directions of the slab and the direction normal to the slab are of the order of 1.6.

This anisotropy is accompanied by a very great improvement in the airtightness performance relative to air.

It is therefore very useful, for improving the airtightness performance relative to air of materials based on SIBS and on platy fillers, to favour the implementation processes that make it possible to generate anisotropic materials such that:

E_{X}′/E_{Z}′>1.2 and E_{Y}′/E_{Z}′>1.2 and preferably such that E_{X}′/E_{Z}′>1.5 and E_{Y}′/E_{Z}′>1.5.

1-19. (canceled)

20. A pneumatic object or inflatable article comprising a gastight elastomer layer,
wherein the elastomer layer includes, as a sole elastomer or as a predominant elastomer by weight, at least one thermoplastic polyisobutylene block elastomer and a platy filler, and
wherein relationships of:
E_{X}′/E_{Z}′>1.2 and E_{Y}′/E_{Z}′>1.2
apply for the elastomer layer, with Z being a direction normal to the elastomer layer, X and Y being directions orthogonal to Z, and E_{X}′, E_{Y}′ and E_{Z}′ being dynamic moduli in compression of the elastomer layer in the X, Y, and Z directions, respectively.

21. The pneumatic object or inflatable article according to claim 20, wherein relationships of:
E_{X}′/E_{Z}′>1.5 and E_{Y}′/E_{Z}′>1.5
apply to the elastomer layer.

22. The pneumatic object or inflatable article according to claim 20, wherein a number-average molecular weight of the at least one thermoplastic polyisobutylene block elastomer is between 30,000 and 500,000 g/mol.

23. The pneumatic object or inflatable article according to claim 20, wherein the at least one thermoplastic polyisobutylene block elastomer includes at least one additional thermoplastic block, and wherein the at least one additional thermoplastic block includes at least one polymerized monomer selected from a group consisting of: styrene; methylstyrenes; para-(tert-butyl)styrene; chlorostyrenes; bromostyrenes; fluorostyrenes; para-hydroxystyrene; acenaphthylene; indene; 2-methylindene; 3-methylindene; 4-methylindene; dimethylindenes; 2-phenylindene; 3-phenylindene; 4-phenylindene; isoprene, esters of acrylic acid, crotonic acid, sorbic acid, and methacrylic acid; derivatives of acrylamide; derivatives of methacrylamide; derivatives of acrylonitrile; and derivatives of methacrylonitrile.

24. The pneumatic object or inflatable article according to claim 23, wherein the polymerized monomer is selected from a group consisting of: styrene; methylstyrenes; para-(tert-butyl)styrene; chlorostyrenes; bromostyrenes; fluorostyrenes; and para-hydroxystyrene.

25. The pneumatic object or inflatable article according to claim 24, wherein the at least one thermoplastic polyisobutylene block elastomer is selected from a group consisting of: styrene/isobutylene (“SIB”) diblock copolymers and styrene/isobutylene/styrene (“SIBS”) triblock copolymers.

26. The pneumatic object or inflatable article according to claim 25, wherein the at least one thermoplastic polyisobutylene block elastomer is a styrene/isobutylene/styrene (“SIBS”) block elastomer.

27. The pneumatic object or inflatable article according to claim 23, wherein the polymerized monomer is selected from a group consisting of: acenaphthylene; indene; 2-methylindene; 3-methylindene; 4-methylindene; dimethylindenes; 2-phenylindene; 3-phenylindene; 4-phenylindene; isoprene; esters of acrylic acid, crotonic acid, sorbic acid, and methacrylic acid; derivatives of acrylamide; derivatives of methacrylamide; derivatives of acrylonitrile; and derivatives of methacrylonitrile.

28. The pneumatic object or inflatable article according to claim 20, wherein the at least one thermoplastic polyisobutylene block elastomer is the sole elastomer of the elastomer layer.

29. The pneumatic object or inflatable article according to claim 20, wherein the elastomer layer includes an extender oil at a content of less than 150 parts per 100 parts by weight of thermoplastic polyisobutylene block elastomer, with between 5 and 100 parts by weight being preferable for the content.

30. The pneumatic object or inflatable article according to claim 29, wherein the extender oil is polybutene, with polyisobutylene being preferable for the polybutene.

31. The pneumatic object or inflatable article according to claim 29, wherein a number-average molecular weight of the extender oil is between 200 and 25,000 g/mol.

32. The pneumatic object or inflatable article according to claim 20, wherein the platy filler of the elastomer layer is present at a content of between 2% and 30% by volume, with between 3% and 20% by volume being preferable for the content.

33. The pneumatic object or inflatable article according to claim 20, wherein the platy filler of the elastomer layer is selected from a group of fillers consisting of: graphites, phyllosilicates, and mixtures thereof.

34. The pneumatic object or inflatable article according to claim 33, wherein the platy filler is selected from micas.

35. The pneumatic object or inflatable article according to claim 20, wherein the pneumatic object is made of rubber.

36. The pneumatic object or inflatable article according to claim 35, wherein the pneumatic object is a pneumatic tyre.

37. The pneumatic object or inflatable article according to claim 35, wherein the pneumatic object is an inner tube.

38. The pneumatic object or inflatable article according to claim 37, wherein the inner tube is a pneumatic tyre inner tube.
